(19) United States
(12) Patent Application Publication
(10) Pub. No.: US 2011/0198919 A1
(43) Pub. Date: Aug. 18, 2011

(54) Circuit Board

(75) Inventors: Yukio HATTORI, Hitachinaka-shi (JP); Kinya Nakatsu, Hitachinaka-shi (JP)

(73) Assignee: Hitachi Cable, Ltd., Tokyo (JP)

(21) Appl. No.: 13/028,982

(22) Filed: Feb. 16, 2011

(30) Foreign Application Priority Data
Feb. 17, 2010 (JP) 2010-031930

(51) Int. Cl. B60L 3/00

(52) U.S. Cl. 307/9.1

(57) ABSTRACT

A circuit board, included in an inverter device that outputs AC current to a motor for driving a vehicle, includes: an insulation layer; a first conductor formed on a first side of the insulation layer, and upon which a semiconductor chip included in a lower arm of an inverter circuit is mounted; a second conductor formed on a second side of the insulation layer opposite to the first side thereof, and connected to a ground of the vehicle; and an inductor connected in parallel with a parasitic capacitance created between the first conductor and the second conductor, thus constituting a parallel resonator together with the parasitic capacitance.

### INCORPORATION BY REFERENCE

The disclosure of the following priority application is herein incorporated by reference: Japanese Patent Application No. 2010-031930 filed Feb. 17, 2010

### BACKGROUND OF THE INVENTION

1. Field of the Invention

The present invention relates to a circuit board and in particular to a circuit board for a power module that is used in a power converter.

2. Description of Related Art

In recent years, along with the progress of electrically driven automobiles, a large number of electrical and electronic components are being mounted to automobiles, and regulation of their electromagnetic compatibility (EMC) has become very strict. Due to this, there is a demand for reduction of radiated emission from various electrical devices such as an onboard inverter and so on, and from a wiring harness that mutually connects these electrical devices together.

In particular, while high speed switching can be usefully implemented due to innovations in the power semiconductor technology that is used in power modules mounted to inverters, the obverse is that the problem occurs of increase of common mode current flowing out to the ground plane via the parasitic capacity in the power module, due to high speed switching fluctuations of the inverter output terminal voltage. This common mode current forms large current loops by wandering around in the ground plane that is shared by a number of devices, and this causes radiated emission to increase undesirably.

In Japanese Laid-Open Patent Publication No. 2008-35657, there is described a countermeasure from the material aspect for raising the impedance of the insulating substrate, by using a thermosetting composite in which an inorganic material is loaded into an epoxy resin as the material for the substrate, so that the dielectric loss in the insulating substrate that constitutes the path for emission becomes high, thus making it more difficult for common mode current to flow in the substrate.

However, with only this countermeasure related to the material for the insulating substrate being implemented, it is found that the precautions against common mode emissions at high frequencies are not always sufficient.

### SUMMARY OF THE INVENTION

The present invention has been conceived in consideration of the problems detailed above, and its object is to prevent common mode current at high frequency from leaking out from a power module.

The power converter according to the present invention employs an insulating substrate (i.e. an insulation layer) of a power module that is mounted in an inverter device that is a structural element of this power converter as a medium, and is endowed with the function of reducing common mode current (leakage current) flowing out to the ground plane (i.e. to earth) via the parasitic capacity between a power semiconductor such as an IGBT or the like positioned upon the upper surface of the insulating substrate, and the mounting surface of a metallic base plate that is positioned upon its lower surface. In more concrete terms, by an inductor being connected in parallel with the parasitic capacitance of the insulating substrate, the power converter according to the present invention is provided with a construction in which a parallel resonator is formed in this insulating substrate (this corresponds to the invention of the main claim). Since this parallel resonator has a high electrical impedance characteristic at a resonant frequency determined by the abovementioned parasitic capacitance and by the inductor, accordingly the advantageous effect is provided that it intercepts the path of common mode current flowing out to the insulating substrate.

Here, with the present invention, it is possible to manifest the beneficial effects of emissions reduction to the maximum possible degree by setting up parallel resonators as described above at locations between a conductor pattern to which the AC output terminals for each phase where abrupt fluctuations at high voltage take place due to the switching operation of the inverter, in other words the collector electrodes of the lower arms for the various phases of the power module, are connected, and a metallic base plate on the opposite side of the insulating substrate.

The present invention can employ a double-layered substrate having a conductor pattern layer on the upper and lower surfaces of an insulating substrate. In this example of application, a parallel resonator is constructed by inserting a discrete chip inductor between a conductor pattern for a lower arm and a metallic base plate. In this case a discrete chip capacitor for DC-cut is connected in series with the inductor, so that the conductor pattern of the lower arm and the metallic base plate are not continuous for DC.

With the present invention, it is possible to set up the parallel resonator within the insulating substrate by using a conductor pattern on the insulating substrate. At this time, a multi-layered substrate is used that has two or more layers of conductor pattern. The inductor included in this parallel resonator can be implemented by using a conductor pattern layer on the insulating substrate, and by forming a conductor pattern that extends from one outlet of the inductor in a curved spiral shape while taking its own other outlet as a center, so that it approaches that other outlet in a spiral configuration. In the following description, an inductor that is constructed upon a conductor pattern in this manner will be termed a “planar inductor”.

Furthermore, a structure will be disclosed in which a planar inductor is formed by a conductor pattern upon a second insulating substrate. The resonant frequency of the resonator is determined by the inductance of the planar inductor, by the parasitic capacitance formed between the conductor pattern upon the first insulating substrate upon which the corresponding lower arm power semiconductor is implemented and the conductor pattern upon the second insulating substrate, and by the parasitic capacitance formed between the conductor pattern upon the second insulating substrate and the metallic base plate. The parasitic capacitances formed between the board or boards, the overlapping areas between the conductor pattern layers, and the gaps between them may be adjusted as appropriate, in order to obtain the desired resonant frequency. By forming the planar inductor and the parasitic capacitance included in the resonator using a conductor pattern on the second insulating substrate on the layer under the power semiconductor of the lower arm in this manner, it is possible to implement a power module whose size is the same as in the prior art.

According to the present invention, it is possible to prevent common mode current at high frequency from leaking out from the power module.

### BRIEF DESCRIPTION OF THE DRAWINGS

FIG. 1 is a figure showing control blocks of a hybrid electric vehicle;

FIG. 2 is a structural circuit diagram showing an inverter device 140, 142, or 43;

FIG. 3A is a perspective view showing the upper side of a power module 300 according to an embodiment of the present invention;

FIG. 3B is a plan view of this power module 300;

FIG. 3C is a schematic side elevation view of the power module 300;

FIG. 4 is an exploded perspective view of DC terminals of the power module 300 according to this embodiment;

FIGS. 5A and 5B are respectively a perspective view and an exploded perspective view, showing a circuit pattern that includes upper and lower arm series circuits 150;

FIG. 6 is a sectional structural view, showing the layout of a typical power module that is mounted to an inverter;

FIGS. 7A, 7B, and 7C are respectively a cutaway perspective view, a cutaway plan view, and a schematic side view of portions of a power module 300 according to a first embodiment of the present invention;

FIG. 8A is a cutaway perspective view of a second embodiment of the present invention, showing the upper side of a portion of a lower arm circuit 152 to which a lower arm IGBT 330 is mounted;

FIG. 8B is a cutaway plan view of this second embodiment, showing this portion of the lower arm circuit 152 to which the lower arm IGBT 330 is mounted;

FIG. 8C is a schematic cutaway side elevation view of this second embodiment, showing this portion of the lower arm circuit 152 to which the lower arm IGBT 330 is mounted;

FIG. 8D is a schematic figure for this second embodiment, showing upper and lower arm series circuits 150 for which the structure of this embodiment is employed, expressed as circuits;

FIG. 9A is a cutaway perspective view of a third embodiment of the present invention, showing the upper side of a portion of a lower arm circuit 152 to which a lower arm IGBT 330 is mounted;

FIG. 9B is a cutaway plan view of this third embodiment, showing this portion of the lower arm circuit 152 to which the lower arm IGBT 330 is mounted;

FIG. 9C is a schematic cutaway side elevation view of this third embodiment, showing this portion of the lower arm circuit 152 to which the lower arm IGBT 330 is mounted;

FIG. 10A is a cutaway perspective view of a fourth embodiment of the present invention, showing the upper side of a portion of a lower arm circuit 152 to which a lower arm IGBT 330 is mounted;

FIG. 10B is a cutaway plan view showing this portion of the lower arm circuit 152 to which the lower arm IGBT 330 is mounted;

FIG. 10C is a schematic cutaway side elevation view showing this portion of the lower arm circuit 152 to which the lower arm IGBT 330 is mounted;

FIGS. 11A and 11B are equivalent circuit diagrams corresponding to certain embodiments; and

FIG. 12 is a schematic chart showing resonator impedance plotted against frequency.

### DESCRIPTION OF THE PREFERRED EMBODIMENTS

Before explaining these embodiments, certain problems and theory related to the embodiments will be explained.

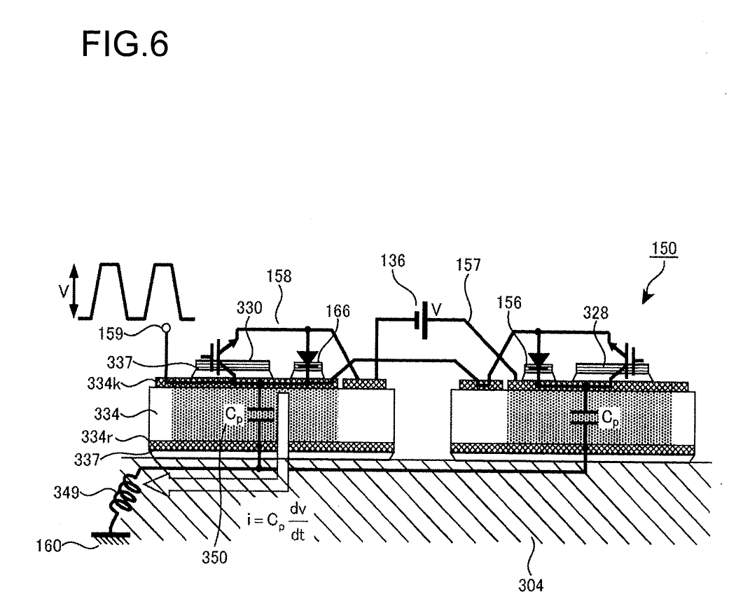

The theory of flow of common mode current from the power module described above via the parasitic capacity of the insulating substrate (i.e. the insulation layer) will now be explained using FIG. 6. FIG. 6 is a structural sectional view of a typical implementation of a power module mounted to an inverter. While, in this example, the explanation is made in terms of the elements for each of the arms for each of the phases of the inverter being implemented independently upon individual boards, the situation would be the same if they were to be implemented upon one board rather than upon a plurality of boards. With regard to the reference symbols in the figure it should be understood that, in some cases, the same reference symbols will be used for corresponding upper arms and lower arms, without any particular notification.

An upper arm IGBT 328 and a lower arm IGBT 330, which are switching elements, are mounted upon insulating substrates (insulation layers) 334, with their collector electrodes facing downwards towards conductor patterns (first conductors) 334k. When implementing these conductor patterns, the IGBTs are fixed in these positions by the use of solder 337. And, in relation to the mounting of diodes 156 and 166 that are arranged in parallel with these IGBTs, these are also fixed upon the conductor patterns in the same way, i.e. by using solder. And other conductor patterns (second conductors) 334r are provided on the lower sides of the insulating substrates 334, i.e. on the opposite sides thereof to the conductor patterns 334k that are on their upper sides, with the bodies of the insulating substrates 334 thus being positioned between these two conductor patterns 334k and 334r.

A metallic base plate 304 is adhered to the conductor patterns 334r by using solder 337, and thereby cools the power semiconductors mounted upon the insulating substrates 334. Thus, parasitic capacitances 350 that constitute common mode current paths are formed at the portions of the insulating substrates 334 where the upper side conductor patterns 334k and the lower side conductor patterns 334r overlap one another with the insulating substrates 334 between them.

Furthermore, the metallic base plate 304 and a ground plane 160 that is connected to the metallic base plate 304 via a metal case of the inverter device have a parasitic inductance 349. For example, in the case of an inverter for a vehicle, the ground plane may correspond to the chassis of the vehicle.

According to the above, this power module can be viewed as a series resonator in virtue of the insulating substrates, since in its construction the parasitic capacitance 350 and the parasitic inductance 349 are connected in series. This series resonator has a characteristic as shown by the broken line in FIG. 12, which is a schematic figure showing the impedances of various resonators plotted against frequency. As shown in FIG. 12, this resonator has low impedance in the region in the vicinity of the resonant frequency fᵣₑₛₒ, and in the region on the low frequency side of the boundary at fᵣₑₛₒ it oscillates capacitively, while on the high frequency side of that boundary it oscillates inductively. This value fᵣₑₛₒ is determined by the parasitic capacitance 350 of the insulating substrate and by the parasitic inductance 349 of the metallic base plate 304 and the ground plane.

Here, the common mode current from the inverter circuit, in other words the leakage current, becomes a problem when the operating frequency of the inverter or a harmonic thereof is located near a frequency at which the insulating substrates 334 of the power module are at low impedance, in other words in the vicinity of fᵣₑₛₒ. At this time, the phenomenon occurs that the common mode current passing through the insulating substrates 334 and flowing out into the ground plane 160 becoming excessively great.

To put this in another manner, the electrical potential of the conductor pattern 334k that connects to the collector electrode of the lower arm IGBT 330, and that is the same as the electrical potential at an output terminal 159 of the inverter, is a square wave (refer to the square wave at the upper left of FIG. 6), and undergoes steep fluctuations of potential according to switching of the upper arm IGBT 328 and the lower arm IGBT 330. In FIG. 6, “i” denotes the common mode current that flows in the insulating substrates 334, “Cₚ” denotes the parasitic capacitance 350 in the insulating substrates 334, and “v” denotes the electric potential of the output terminal 159 of the inverter. The current that flows in the parasitic capacitance 350 in the lower arm due to this potential v of the output of the inverter executing steep fluctuations may be expressed by i=Cₚ(dv/dt). Because of this, at the rising and falling portions of these steep fluctuations of these square waves v, the common mode current i flowing out via the insulating substrates 334 become excessively great. The above is the theory of creation of the common mode current that passes through the insulating substrates 334.

Next, causes for generation of emissions will be explained using concrete numerical values related to chip size, frequency, parasitic capacity, and impedance. To cite an example, in FIG. 6, an IGBT 330 and a diode 166 of the lower arm of one of the phases may be implemented upon a conductor pattern 334k formed upon an insulating substrate 334 of dimensions about 50 mm×30 mm. If a ceramic board having good thermal conductivity is used for the insulating substrate 334, then it may have a parasitic capacitance (Cp) of around 100 pF. With this, the impedance |Z| of the insulating substrate 334 is around 16Ω at 100 MHz, and, when the frequency exceeds 100 MHz, this impedance |Z| becomes a low impedance below 10Ω. According to the above, it will be understood that the emission problem of leakage current flowing via the insulating substrate appears at high frequencies.

In order to eliminate this cause for generation of emissions, it is extremely effective to cut off the emission paths created internally to the power module, because these are the main locations where emissions are generated. Thus, in order to reduce emissions, it has been considered to institute countermeasures within the insulating substrate that constitutes the path for emissions. For example, the countermeasure has been proposed in the prior art of attacking the problem from the point of view of materials by using, as the material for the insulating substrate, a thermosetting composite made from an epoxy resin loaded with an inorganic material, so that the dielectric losses in the insulating substrate become high and in consequence the impedance of the insulating substrate becomes high, which makes the flow of common mode current more difficult.

With this type of countermeasure in which a special type of material whose resistance is high is employed for the insulating substrate, although the impedance becomes high due to dielectric loss in the material, it is necessary to use a material that has a higher dielectric loss in order to institute countermeasures against common mode current at higher frequencies, because the resistance component of the impedance of such an insulating substrate has a value that is inversely proportional to the frequency. However, actually, it is difficult to provide an insulating substrate in which the dielectric loss tangent (tan δ) is higher than 10%. Accordingly, with only the countermeasure of improving the material for the insulating substrate, the countermeasures against common mode emissions at high frequencies are not sufficient. However, with the structure of the embodiments that will be explained in the following, it is possible to reduce common mode emissions at high frequencies.

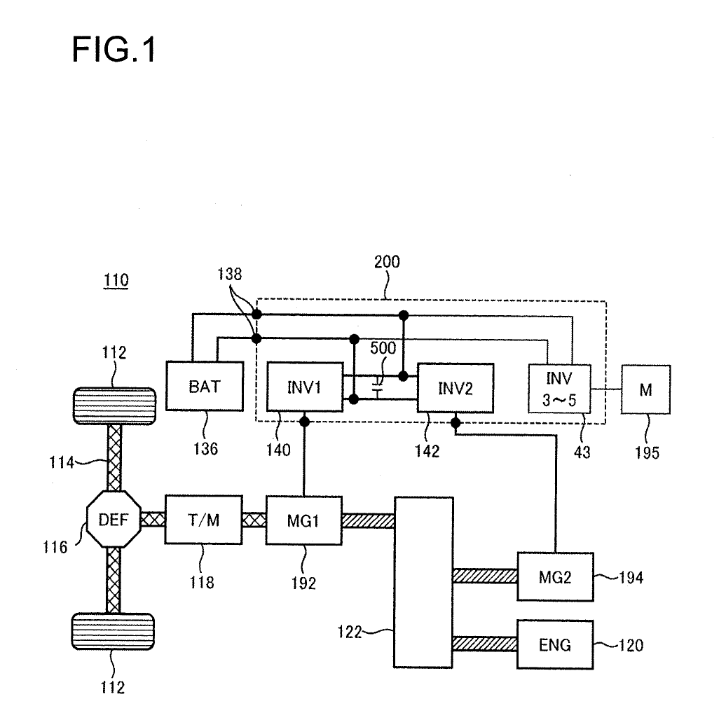

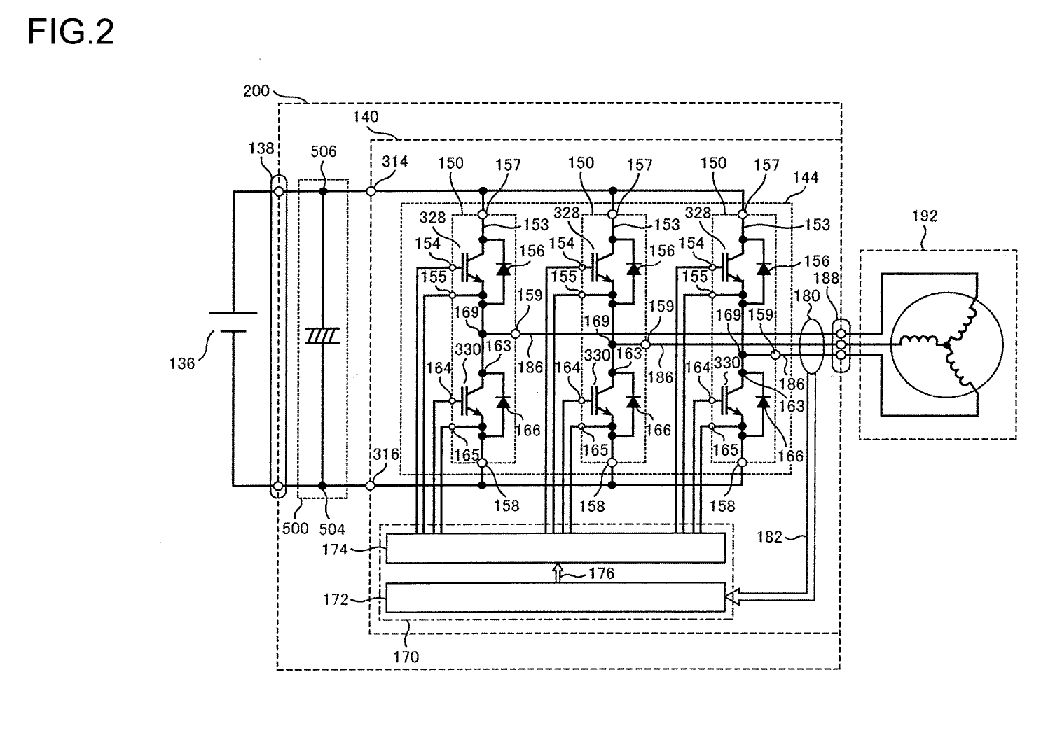

Various power converters according to embodiments of the present invention will now be explained in detail with reference to the drawings. While these power converters according to the embodiments may be applied to a hybrid electric vehicle or to a pure electric vehicle, as a representative example, a control structure and circuit structure for the case of application to a hybrid electric vehicle will be explained using FIGS. 1 and 2.

FIG. 1 is a figure showing control blocks of a hybrid electric vehicle. With the power converter according to this embodiment that is used in an electrical system for driving a vehicle, an example will be cited and explained of an inverter device for powering the vehicle, that is subjected to a very demanding and severe mounting environment and operating environment and so on.

This inverter device for driving a vehicle converts DC power supplied from an onboard battery or onboard electricity generation device that constitutes an onboard power supply into predetermined AC power, and supplies this AC power that has been thus produced to an electric motor for propelling the vehicle and controls the operation of this electric motor for propelling the vehicle. Moreover since, according to its operational mode, the electric motor for propelling the vehicle is also endowed with the function of serving as a generator, accordingly the inverter device for driving the vehicle also is endowed with the function of converting AC power generated by the electric motor for driving the vehicle into DC power.

It should be understood that, while the structure of this embodiment is optimized as a power converter for driving a vehicle such as an automobile or a truck or the like, it may also be applied to power converters of other types: for example, this power converter could also be applied to a power converter for a train or a ship or an aircraft or the like, to a power converter for use in industry as a control device for an electric motor that drives a machine in a workplace, or to a power converter for household use that is employed as a control device for an electric motor that drives a home solar electricity generating system or an item of electrified household equipment or the like.

In FIG. 1, a hybrid electric vehicle (hereinafter termed a “HEV”) 110 is a single electrically operated vehicle that is equipped with two vehicle drive systems. One of these is an engine system that utilizes an internal combustion engine 120 as its power source. This engine system is used as the principal drive source for propelling the HEV 110. The other drive system is an onboard electrical system that utilizes two motor-generators 192 and 194 as power sources. This onboard electrical system is principally used as a drive power source for the HEV and as an electrical power generating source for the HEY. The motor-generators 192 and 194 may be, for example, synchronous machines or induction machines, and since, in terms of their method of operation, they can function both as motors and as generators, in this specification they will be termed “motor-generators”.

A front wheel shaft 114 is rotatably supported at the front portion of the body of the vehicle, and a pair of front wheels 112 are provided at the both ends of the front wheel shaft 114. Rear wheel shaft is rotatably supported at the rear portion of the vehicle body, and a pair of rear wheels (not shown in the figures) are provided at the both ends of the rear wheel shaft. While, with the HEV of this embodiment, the so-called front wheel drive configuration is employed, the present invention could also be applied to the reverse configuration, i.e. to an HEV that employs the rear wheel drive configuration. A front wheel side differential gear system 116 (hereinafter termed the “front wheel DEF”) is provided at the central portion of the front wheel shaft 114. The output shaft of a speed change mechanism 118 is mechanically connected to an input side of this front wheel DEF 116. And the output side of the motor-generator 192 is mechanically connected to the input side of the speed change mechanism 118. Furthermore, the output side of the engine 120 and the output side of the motor-generator 194 are mechanically connected to the input side of the motor-generator 192 via a drive force distribution mechanism 122. It should be understood that the motor-generators 192 and 194 and the drive force distribution mechanism 122 are housed in the interior of the case of the speed change mechanism 118.

A battery 136 is electrically connected to the inverter devices 140 and 142, and power can be mutually transferred between the battery 136 and the inverter devices 140 and 142. In this embodiment there are provided two grouped electric drive/generator units, i.e. a first electric drive/generator unit that includes the motor-generator 192 and the inverter device 140, and a second electric drive/generator unit that includes the motor-generator 194 and the inverter device 142; and usage is divided between these according to the current operational state. In other words, when the vehicle is being propelled by the drive force from the engine 120, if the drive torque of the vehicle is to be assisted, then the second electric drive/generator unit is operated as an electricity generation unit by the drive force from the engine 120, while the first electric drive/generator unit is operated as an electric drive unit using the power that is generated in this way. Moreover, in a similar way, if the speed of the vehicle is to be assisted, then the first electric drive/generator unit is operated as an electricity generation unit by the rotational force from the engine 120, while the second electric drive/generator unit is operated as an electrical drive unit using the power that is generated in this way.

Furthermore, with this embodiment, it is possible to operate the first electric drive/generator unit as an electrical drive unit using the power of the battery 136, so as to propel the vehicle only with the drive force of the motor-generator 192. Yet further, with this embodiment, it is possible to operate either the first electric drive/generator unit or the second electric drive/generator unit as an electricity generation unit with power from the engine 120, or with power from the vehicle wheels, so as to charge up the battery 136.

The battery 136 is also used as a power supply for driving an auxiliary machinery motor 195. In vehicle auxiliary machinery there may be incorporated, for example, a motor that drives a compressor for an air conditioner, or a motor that drives a hydraulic pump for control or the like: DC power is supplied from the battery 136 to the inverter device 43, and is converted into AC power by the inverter device 43 and is supplied to the motor 195. This inverter device 43 functions in a manner similar to that of the inverter devices 140 and 142, and controls the phase, the frequency, and the power of the AC that it supplies to the motor 195. For example, the motor 195 can generate torque due to AC power being supplied having a phase that leads with respect to the rotation of the rotor of the motor 195. Conversely, the motor 195 can operate as a generator by AC power having a delayed phase being generated, so that the motor 195 performs regenerative braking operation. This type of control function for the inverter device 43 is the same as the control function for the inverter devices 140 and 142. Since the capacity of the motor 195 is smaller than the capacities of the motor-generators 192 and 194, accordingly the maximum power conversion capability of the inverter device 43 is smaller than those of the inverter devices 140 and 142; but, fundamentally, the circuit structure of the inverter device 43 is the same as the circuit structures of the inverter devices 140 and 142.

Next, the circuit structure of one of the inverter devices 140 and 142, or of the inverter device 43, will be explained with reference to FIG. 2. It should be understood that since, in the embodiment shown in FIGS. 1 and 2, each of the inverter devices 140, 142, and 43 has similar circuit structure and operates in a similar manner and has similar functions, accordingly here the inverter device 140 will be explained as a representative example.

The power converter 200 according to this embodiment includes the inverter device 140 and a capacitor module 500, and the inverter device 140 includes a inverter circuit 144 and a control unit 170. Moreover, the inverter circuit 144 includes upper and lower arm series circuits 150 for three phases (i.e. the U phase, the V phase, and the W phase) each corresponding to armature winding of the motor-generator 192 for each phase, with each of these upper and lower arm series circuits 150 including an IGBT (Insulated Gate Bipolar Transistors) 328 and a diode 156 that operate as an upper arm, and an IGBT 330 and a diode 166 that operate as a lower arm. An intermediate point (i.e. an intermediate electrode) 169 of each of the pairs of upper and lower arm series circuits 150 is connected via an AC terminal 159 and an AC connector 188 to an AC power line (i.e. an AC bus bar) 186, thus being connected via the AC power line 186 to the motor-generator 192. The collector electrodes 153 of the upper arm IGBTs 328 are connected via positive terminals (i.e. P terminals) 157 to the positive electrode side of the capacitor module 500, while the emitter electrodes of the lower arm IGBTs 330 are connected via negative terminals (i.e. N terminals) 158 to the negative electrode side of the capacitor module 500 (that is, these connections are established via DC bus bars).

Moreover, the control unit 170 includes a driver circuit 174 that controls the operation of the inverter circuit 144, and a control circuit 172 that supplies control signals to the driver circuit 174 via a signal line 176.

The IGBTs 328 and 330 in the upper and lower arms are power semiconductor elements for switching, and are operated by drive signals from the control unit 170 so as to convert DC power supplied from the battery 136 into three phase AC power. This AC power that has thus been converted is supplied to the armature windings of the motor-generator 192.

The inverter circuit 144 is built as a three phase bridge circuit, with each of the upper and lower arm series circuits 150 for each of the three phases being electrically connected in parallel between a DC positive terminal 314 and a DC negative terminal 316, which are respectively connected to the positive electrode side and to the negative electrode side of the battery 136. The upper arm IGBTs 328 have collector electrodes 153, emitter electrodes (signal emitter electrode terminals) 155, and gate electrodes (gate electrode terminals) 154. The diodes 156 are electrically connected between the collector electrodes 153 of the IGBTs 328 and their emitter electrodes, as shown in the figure. It would also be acceptable to use MOSFETs (Metal Oxide Semiconductor Field Effect Transistors) as these switching power semiconductor elements. In such a case, the diodes 156 and 166 would not be required.

The capacitor module 500 acts as a smoothing circuit for suppressing fluctuations of the DC voltage generated by the switching operation of the IGBTs 328 and 330. Via DC connectors 138, the positive pole side of the battery 136 is connected to the positive pole side capacitor electrode of the capacitor module 500, while the negative pole side of the battery 136 is connected to the negative pole side capacitor electrode of the capacitor module 500.

The control circuit 172 includes a microcomputer (not shown in the figures) that performs processing for calculating the switching timings for the IGBTs 328 and 330. As input information, a target torque value that is requested for the motor-generator 192, values of the currents being supplied to the armature windings of the motor-generator 192 from the upper and lower arm series circuits 150, and the position of the magnetic poles of the rotor of the motor-generator 192, are inputted to this microcomputer. The target torque value is a value based upon a command signal outputted from a higher level control device not shown in the figures. And the current values are values that are determined on the basis of detection signal outputted from a current sensor 180. Moreover, the magnetic pole position is a value that is determined on the basis of a detection signal outputted from a magnetic pole rotation sensor not shown in the figures that is provided to the motor-generator 192. While in this embodiment an example is described in which the AC current value for each of the three phases is detected, it would also be acceptable to arrange to detect AC current values for only two of the phases.

The microcomputer incorporated in the control circuit 172 calculates current command values for the d and q axes of the motor-generator 192 on the basis of the target torque value, and then calculates voltage command values for the d and q axes on the basis of the differences between the current command values for the d and q axes that are the result of the above calculation and the current values for the d and q axes that have been detected; and then the microcomputer converts these voltage command values for the d and q axes into voltage command values for the U phase, the V phase, and the W phase on the basis of the detected magnetic pole position. And the microcomputer generates modulated pulse form waves on the basis of comparison between fundamental waves (i.e. sine waves) based upon the U phase, V phase, and W phase voltage command values and a carrier wave (i.e. a triangular wave), and outputs these modulated signals that have been generated to the driver circuit 174 as PWM (pulse width modulated) signals.

When driving a lower arm, the driver circuit 174 amplifies the PWM signal and outputs it as a drive signal to the gate electrode of the IGBT 330 of the corresponding lower arm; while, when driving an upper arm, it amplifies the PWM signal after having shifted the level of the reference potential of this PWM signal to the level of the reference potential of the upper arm, and outputs it as a drive signal to the gate electrode of the IGBT 328 of the corresponding upper arm.

Moreover, the control unit 170 performs detection of anomalies such as excess current, excess voltage, excess temperature and so on, and thereby protects the upper and lower arm series circuits 150. For this purpose, sensing information is input to the control unit 170. For example, information about the current that flows to the emitter electrode of each of the IGBTs 328 and 330 is input from signal emission electrode terminals 155 and 165 of each arm to the corresponding drive unit (IC). Based upon this, each of the drive units (ICs) performs excess current detection, and stops the switching operation of the corresponding IGBT 328 or 330 if it has detected excess current, thus protecting the corresponding IGBT 328 or 330 from excessive current. Furthermore, information about the temperatures of the upper and lower arm series circuits 150 is input to the microcomputer from temperature sensors (not shown in the figures) that are provided to the upper and lower arm series circuits 150. Yet further, information about the voltages at the DC positive electrode sides of the upper and lower arm series circuits 150 is input to the microcomputer. The microcomputer performs excess temperature detection and excess voltage detection on the basis of this information, and stops the switching operation of all of the IGBTs 328 and 330 if it detects excess temperature or excess voltage, thus protecting the upper and lower arm series circuits 150 (and also the semiconductor module that includes these circuits 150) from excess temperature and excess voltage.

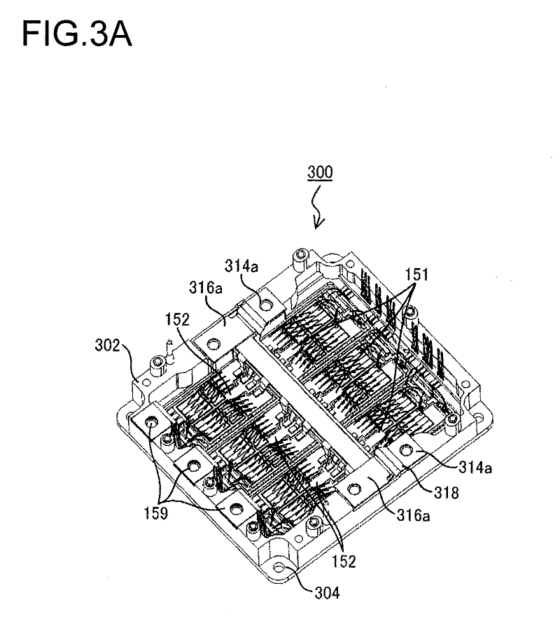

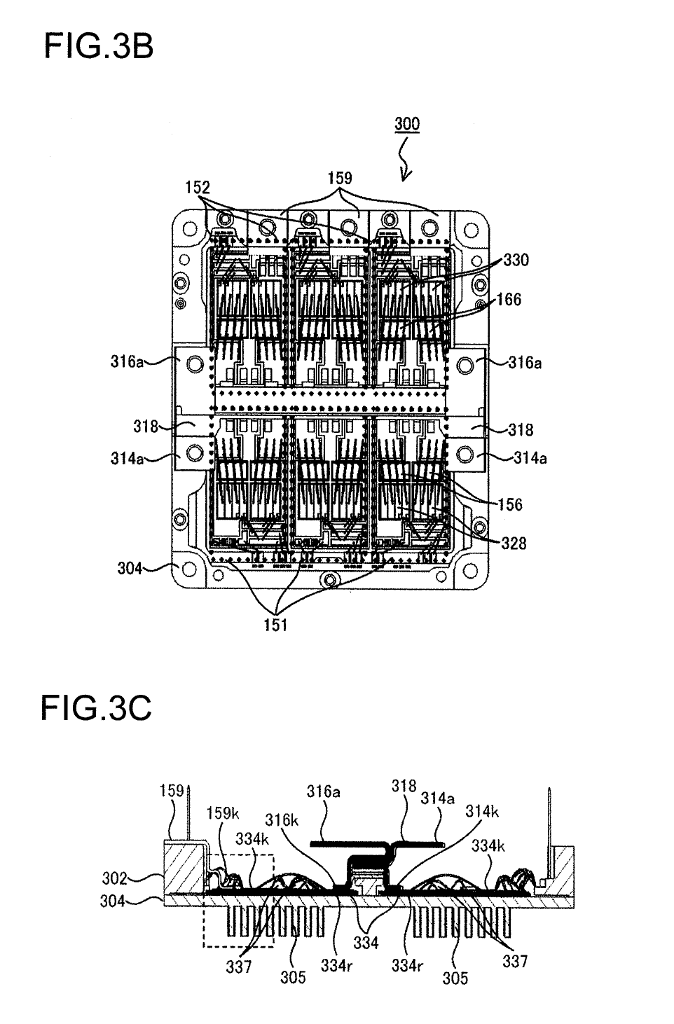

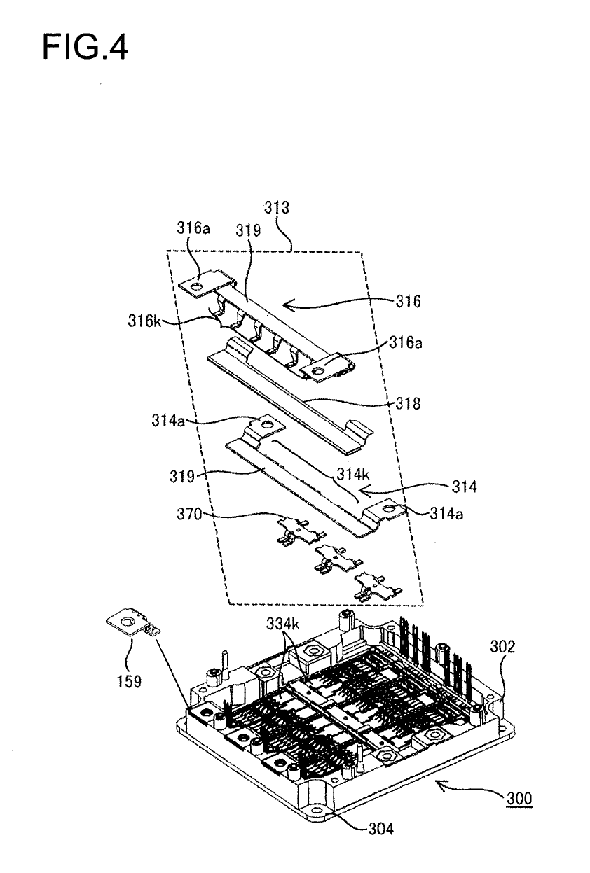

FIG. 3A is a perspective view showing the upper side of a power module 300 according to this embodiment of the present invention, FIG. 3B is a plan view of this power module 300, and FIG. 3C is a side elevation view of the power module 300. Moreover, FIG. 4 is an exploded perspective view of DC terminals of this power module 300 according to this embodiment.

As shown in FIG. 4, this power module 300 includes a semiconductor module portion including various circuitry such as upper arm circuits 151 and lower arm circuits 152 within a power module case 302 made from (for example) a resin material, a metallic base plate 304 that is made from a metallic material (for example from Cu, Al, AlSiC or the like), AC terminals 159 for the U, V, and W phases that serve as external connection terminals and to which the motor-generator is connected, and the DC positive terminal 314 and the DC negative terminal 316 that are connected to the capacitor module 500. The DC positive terminal 314 and the DC negative terminal 316 are laid against one another with insulating paper 318 being interposed between them (refer to FIG. 4).

Furthermore, in this semiconductor module portion, the upper arm IGBTs 328, the lower arm IGBTs 330, and the diodes 156 and 166 and so on are fixed to mounting surfaces upon conductor patterns 334k on insulating substrates 334, and are protected by resin or silicon gel (not shown in the figures). While ceramic boards having good thermal conductivity are used here for the insulating substrates 334, it would also be acceptable to employ resin boards. Moreover, conductor patterns 334r on the insulating substrates 334 and the metallic base plate 304 for heat dissipation are connected together by the use of solder 337.

As shown in FIG. 3C, the metallic base plate 304 has fin shapes 305 on its side opposite to the insulating substrate 334, in order to provide heat dissipation with good efficiency to cooling water (i.e. a cooling medium) that flows in a cooling water conduit. Moreover, the IGBTs and diodes that constitute the inverter circuit are mounted on one side of the metallic base plate 304, and the power module case 302 that is made from resin is provided around the external periphery of the metallic base plate 304.

As shown in FIG. 4, DC terminals 313 housed within the power module 300 are made in a laminated construction, in which the DC negative terminal 316 and the DC positive terminal 314 are laid over one another with the interposition of the insulating paper 318. Moreover, end portions of the DC negative terminal 316 and the DC positive terminal 314 are curved around so as to extend outwards in mutually opposite directions, and constitute negative electrode connection portions 316a and positive electrode connection portions 314a for electrically connecting DC bus bars having a laminated construction to the power module 300.

Furthermore, the DC positive terminal 314 and the DC negative terminal 316 have connection tags 314k and 316k for connection to the circuit conductor pattern 334k. And these connection tags 314k and 316k project in the direction towards the circuit conductor pattern 334k, and moreover are bent around at their tip end portions, in order to provide junction surfaces with the circuit conductor pattern 334k. These connection tags 314k and 316k may be connected to the circuit conductor pattern 334k by solder or the like, or may be directly connected thereto by ultrasonic welding.

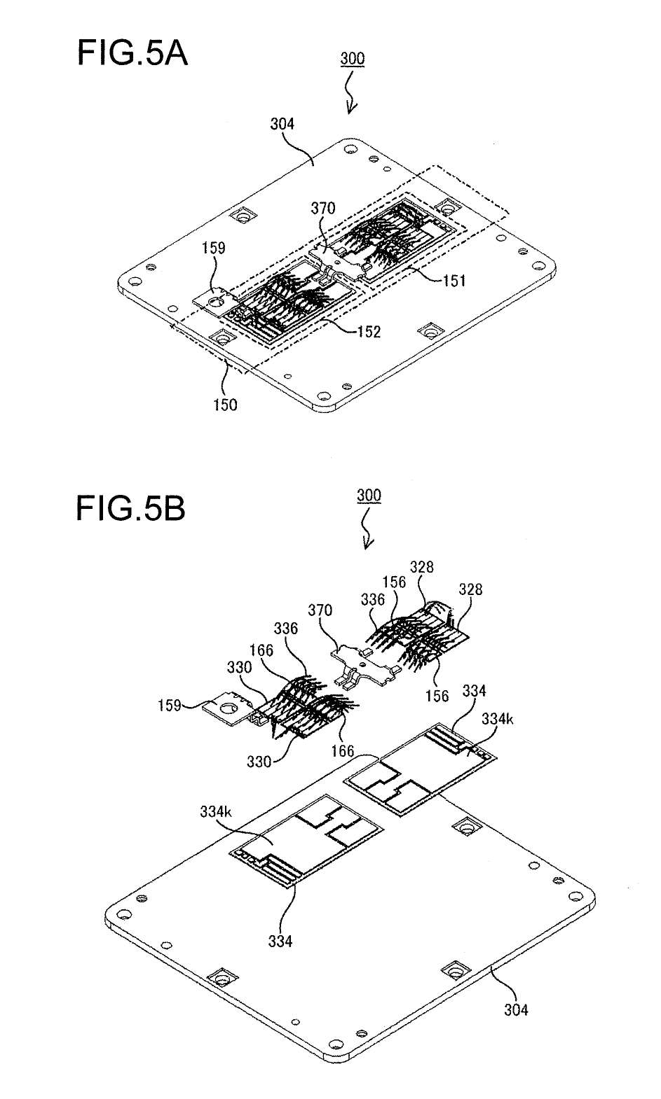

As shown in FIG. 5A, the upper and lower arm series circuits 150 are provided with the upper arm circuits 151 and the lower arm circuits 152, with terminals 370 for connecting these upper arm circuits 151 and lower arm circuits 152, and with the AC terminals 159 for outputting AC power. Moreover, as shown in FIG. 5B, upon the metallic base plate 304, each of the upper arm circuits 151 and the lower arm circuits 152 is provided with an insulating substrate 334 upon which its circuit conductor pattern 334k is formed, and furthermore the IGBTs 328 and 330 and the diodes 156 and 166 are mounted upon these circuit conductor patterns 334k.

In each upper arm circuit 151, the collector electrode of its upper arm IGBT 328 that is positioned on the rear surface of which upper arm IGBT 328 and the cathode electrode of the diode 156 that is positioned on the rear surface of that diode 156 are joined together by the circuit conductor pattern 334k and solder 337. The insulating substrate 334 upon which the circuit conductor pattern 334k is formed has no pattern on its surface 334r opposite to that circuit conductor pattern 334k (i.e. on its rear surface), in other words it is formed with a so-called “solid pattern”. This solid pattern on the rear surface of the insulating substrate and the metallic base plate 304 are joined together by solder 337. Similarly to the upper arm circuits 151, the lower arm circuits 152 as well include insulating substrates 334 disposed upon the metallic base plate 304, circuit conductor patterns 334k formed upon these insulating substrates 334, and lower arm IGBTs 330 and diodes 166 mounted upon these circuit conductor patterns 334k.

It should be understood that, in this embodiment, each of the arms for each of the phases includes two circuit groups connected in parallel, each of these circuit groups including one IGBT and one diode connected in parallel. The number of such circuit groups to be connected in parallel in each arm may be determined according to the current flow rate that is to be supplied to the motor-generator 192. If a greater current is needed to be supplied to the motor-generator 192 than the current provided by this embodiment, then three or more of these circuit groups may be connected in parallel in each of the upper and lower arms. Conversely, if it is possible to drive the motor-generator 192 with a relatively small current, then it will be sufficient to provide only one of these circuit groups in each of the upper and lower arms.

### Embodiment 1

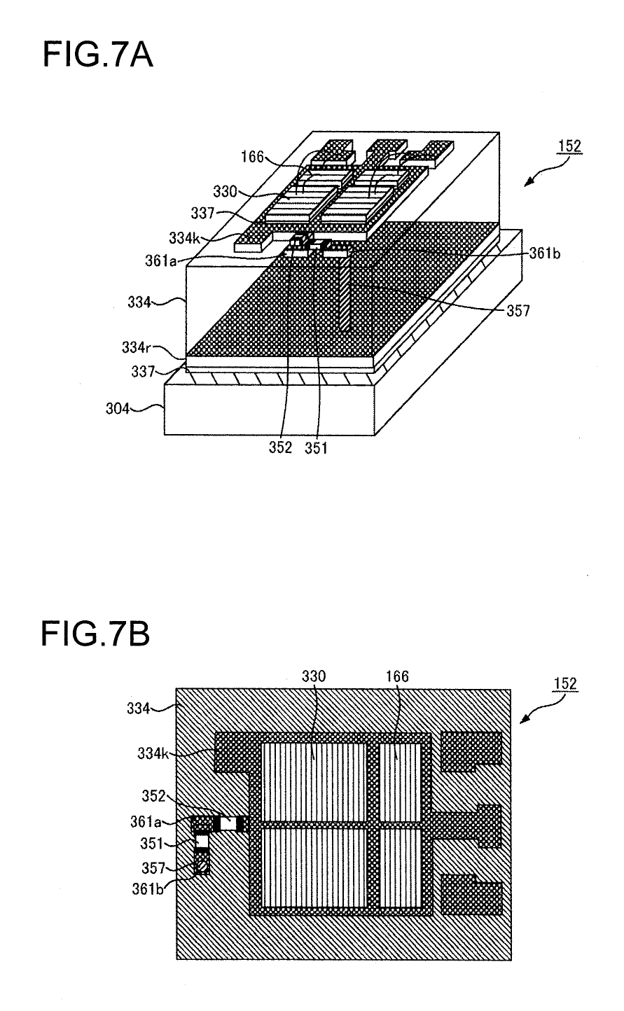

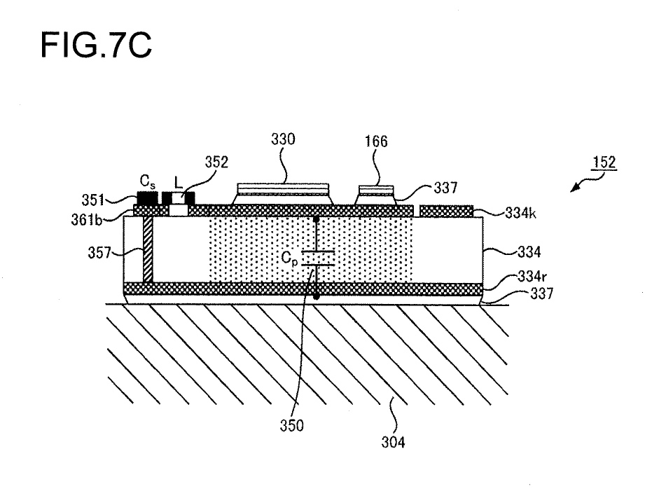

FIGS. 7A, 7B, and 7C are enlarged partial views of a power module 300 according to this embodiment. When the electrical potential at the output AC terminals 159 for each of the phases of the power module 300 shown in FIGS. 3A, 3B, and 3C fluctuates abruptly according to the magnitude of the voltage of the battery 136, common mode current (i.e. leakage current) flows to the metallic base plate 304, and moreover, particularly in the case of employment in a vehicle, it flows to the ground plane 160 such as a chassis or the like that is connected to that metallic base plate 304, via the parasitic capacity (Cₚ) 350 of the insulating substrate 334 shown in FIG. 7C.

However, in this embodiment, outflow of such common mode current is suppressed by ensuring high impedance for the insulating substrates 334 of the lower arms for each phase, that are the main outflow paths for common mode currents.

FIG. 7A is a partially cut away perspective view from above, showing a portion of one of the lower arm circuits 152 to which a lower arm IGBT 330 is mounted. Here, only the main parts will be described in order to avoid troublesome description. And FIG. 7B is a plan view thereof, while FIG. 7C is a schematic side elevation view thereof.

The parasitic capacitance (Cₚ) 350 of the insulating substrate 334 is formed by the overlapping portion of the conductor pattern 334k that is contacted by the collector surface of the lower arm IGBT 330 and the conductor pattern 334r on the side of the metallic base plate 304. The distinguishing feature of this embodiment is that, in order electrically to enhance the impedance of the insulating substrate 334, a discrete chip inductor (L) 352 is mounted on the surface of the conductor pattern 334k upon the insulating substrate 334, so that this discrete chip inductor 352 is arranged in parallel with the parasitic capacitance (Cₚ). It should be understood that a discrete chip capacitor (Cₛ) 351 is connected in series with this discrete chip inductor 352, in order to prevent the conductor pattern 334k and the metallic base plate 304 from being continuous to DC.

One terminal of this discrete chip inductor 352 is connected to the conductor pattern 334k, and the other terminal thereof is connected to a connecting conductor 361a. And one terminal of the discrete chip capacitor (Cₛ) 351 is connected to the connecting conductor 361a, while the other terminal thereof is connected to a connecting conductor 361b. This connecting conductor 361b is connected to a through-hole (i.e. connecting conductor) 357 for joining together the conductor pattern 334k and the conductor pattern 334r. In other words, the discrete chip inductor 352, the discrete chip capacitor (Cₛ) 351, the connecting conductor 361a, and the connecting conductor 361b are electrically connected in series. It should be understood that the connecting conductor 361a and the connecting conductor 361b are disposed on the side of the insulating substrate 334 on which the conductor pattern 334k is disposed.

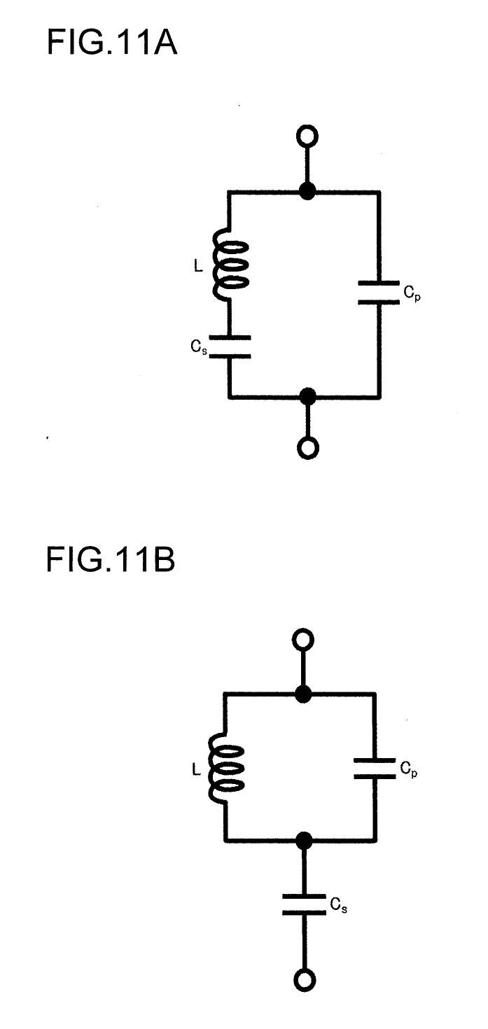

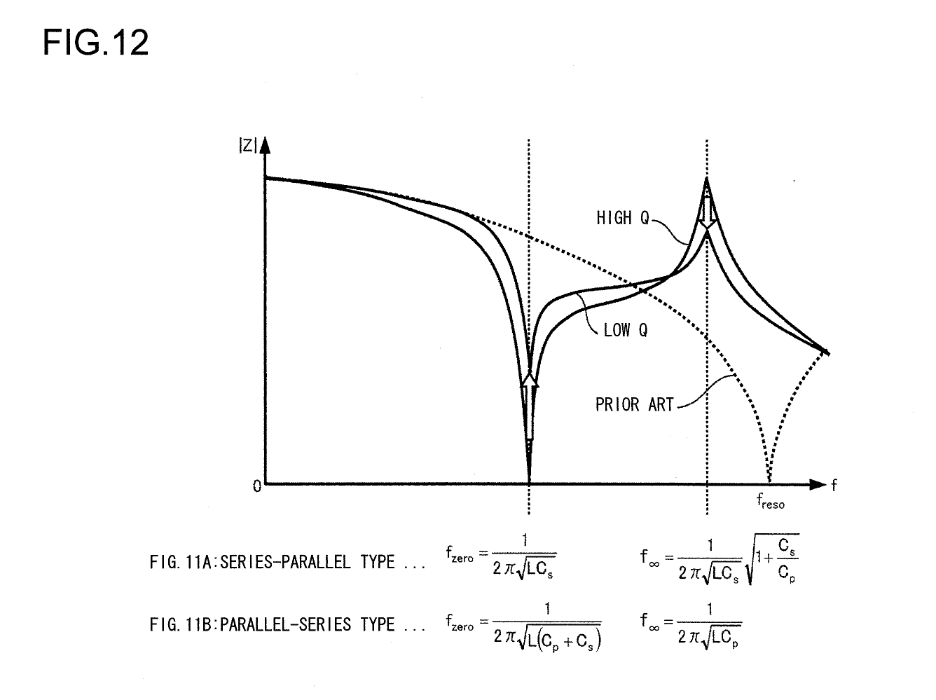

With the structure described above, the insulating substrate 334 constitutes a series-parallel type LC resonator, as shown in FIG. 11A. As shown by the solid line in the schematic graph of FIG. 12, the impedance characteristic |Z| of this resonator has a pole frequency at which it has high impedance given by:

$${f}_{∞} = \frac{1}{2 π \sqrt{{LC}_{s}}} \sqrt{1 + \frac{{C}_{s}}{{C}_{p}}}$$

and a zero frequency at which it has low impedance given by:

$${f}_{zero} = \frac{1}{2 π \sqrt{{LC}_{s}}}$$

If it is supposed that the quality factor (Q) of the resonator is infinitely great, then the |Z| of this LC resonator has a locally maximum value at the pole frequency f_{∞} (this may be viewed as parallel resonance), and has a very small value at the zero frequency f_{zero} (this may be viewed as series resonance); and, while at the pole frequency f_{∞} it is possible to reduce the common mode current (i.e. the leakage current) via the insulating substrate 334 down to infinitely small, at the zero frequency f_{zero}, there is a danger that a common mode current having this frequency component may pass through the insulating substrate.

However the actual quality factor (Q) of the resonator is finite, because the actual inductor has a resistance component. In this embodiment, while at the zero frequency f_{zero} a frequency region exists in which the LC resonator has undesirably low impedance, it is possible to increase the magnitude |Z| of the impedance of the LC resonator in this frequency region in which it has low impedance by intentionally reducing the quality factor (Q) of the resonator, in other words of the inductor. By employing this procedure, it is possible to prevent any danger of an excessively great flow of common mode current having a frequency component equal to the zero frequency f_{zero}.

As an actual method for reducing the quality factor (Q) of the resonator, it is possible to connect a chip resistor in series with the discrete chip inductor 352, or to reduce the width of the wiring of the conductor pattern 334k upon which the discrete chip inductor is mounted. Here, intentionally reducing the quality factor (Q) of the resonator operates to flatten the characteristic of the impedance |Z| with respect to frequency by reducing the |Z| at the pole frequency f_{∞} where the impedance is high. Due to this, it is possible to make the impedance of the insulating substrate 334 be higher than in the prior art over a wide band, from DC to high frequencies. Or, if it is the primary objective to suppress common mode current at high frequency and it is necessary to keep the insulating substrate 334 at high impedance in this frequency region under consideration, then, by performing optimization of the discrete chip inductor (L) 352 and the discrete chip capacitor (Cₛ) 351 so that the zero frequency f_{zero} at which the impedance is low is positioned within a frequency band for which no emissions standard is defined, it is possible to prevent occurrence of the problem at the zero frequency f_{zero} of the resonator mounted upon the insulating substrate 334.

### Embodiment 2

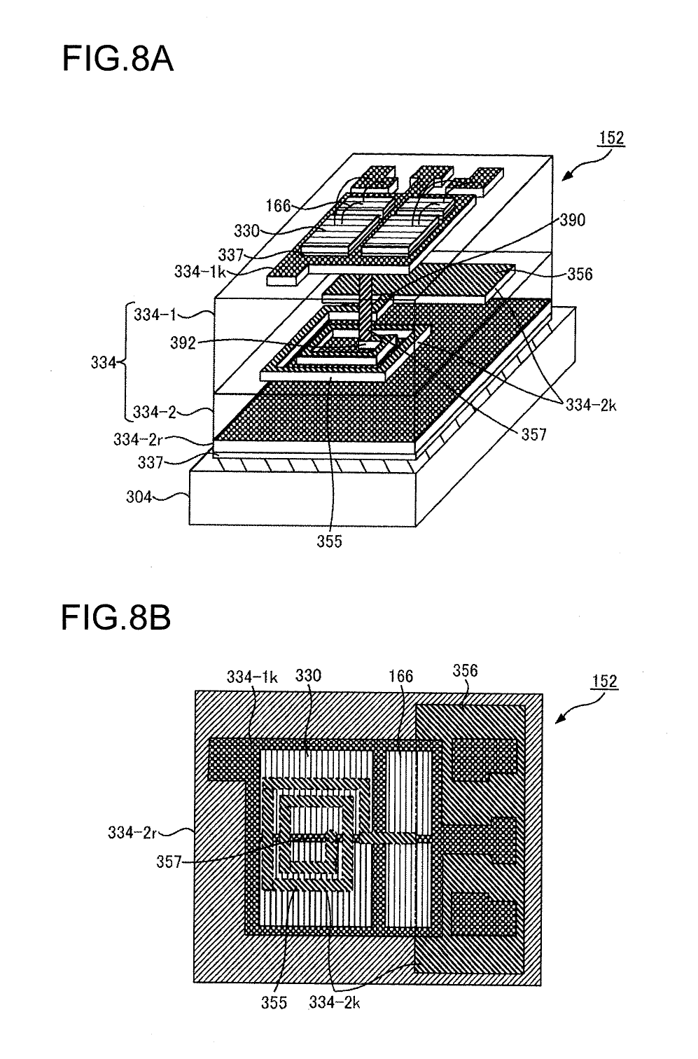

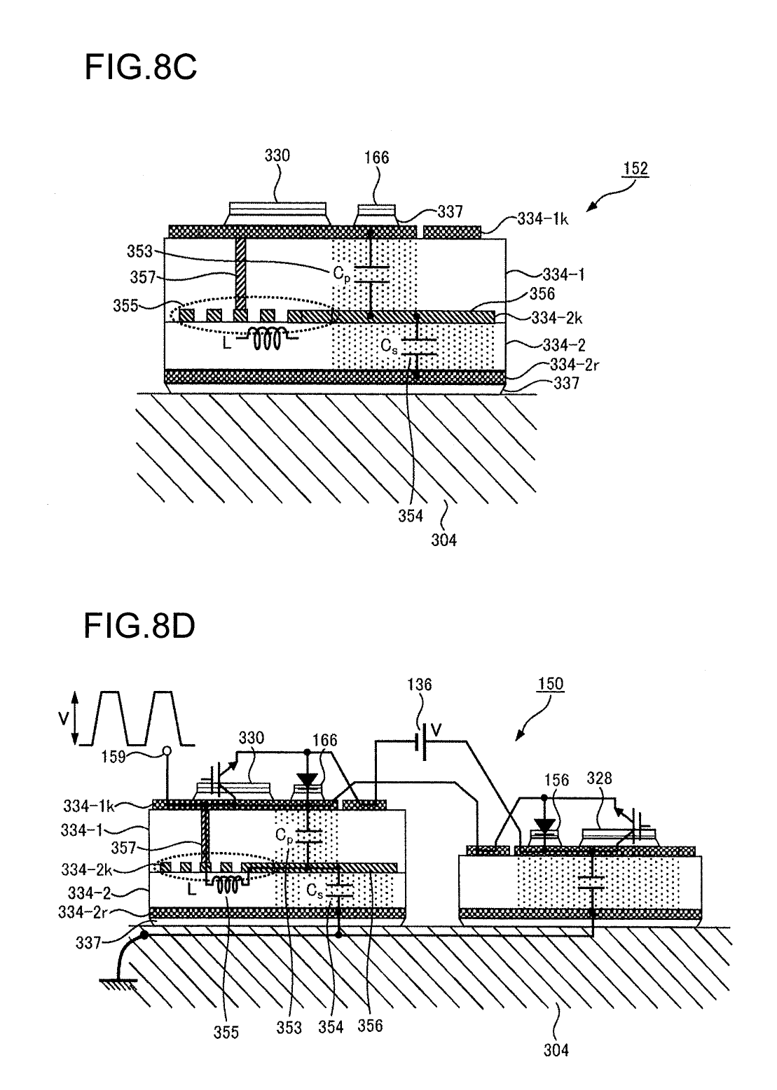

FIG. 8A is a cutaway perspective view of a second embodiment of the present invention, showing the upper side of a portion of a lower arm circuit 152 to which a lower arm IGBT 330 is mounted. And FIG. 8B is a cutaway plan view thereof, while FIG. 8C is a schematic cutaway side elevation view thereof, and FIG. 8D is a schematic figure showing upper and lower arm series circuits 150 that employ the structure of this embodiment, expressed as circuits.

The distinguishing feature of this embodiment is that, in order electrically to enhance the impedance of the insulating substrate 334, a parallel resonator is provided within the insulating substrate by employing the conductor pattern upon the insulating substrate. By employing this structure, it is possible to implement a power module that is endowed with common mode emissions countermeasures, while still having a surface area equal to that of a prior art power module.

The inductor (L) 355 that is used in this parallel resonator is implemented by forming a conductor pattern extending from one end portion 390 of this inductor as a spiral shape by using the conductor pattern layer within the insulating substrate, and by bending or curving this spiral shape around and around its other end portion 392 as a center, while progressively approaching that other end portion 392. The inductor (L) 355 that is formed in this manner will hereinafter be termed a “planar inductor”.

It should be understood that this embodiment is implemented using a two-layer insulating substrate that is provided with conductor patterns on three layers: its upper surface, its lower surface, and a third layer formed between them. The insulating substrate upon whose upper surface the lower arm IGBTs 330 are mounted will be termed the first insulating substrate 334-1, while the other insulating substrate whose bottom surface contacts the metallic base plate will be termed the second insulating substrate 334-2.

The planar inductor (L) 355 (formed between the insulating layers) is made by using the conductor pattern 334-2 (i.e. the middle conductor) that is positioned on the upper side of the second insulating substrate 334-2, and its inductance is determined by the external diameter of its spiral shape, its number of turns, the width of its spiral conductor, and the space between its turns. One of the outlets of this planar inductor 355 is connected via a through-hole 357 (i.e. a connecting conductor) to the conductor pattern 334-1k (i.e. to the first conductor) on the first insulating substrate, so that the planar inductor 355 and a parasitic capacitance (Cₚ) that will be described hereinafter with the first insulating substrate are arranged in parallel. And the other outlet of the planar inductor 355 is connected to a metal plate 356 that is formed by the conductor pattern 334-2k on the second insulating substrate, i.e. on the same layer.

Moreover, as shown in FIG. 8C, the insulating substrates included in this LC resonator have certain capacitances Cₚ and Cₛ. The former capacitance Cₚ is determined by the area by which the conductor pattern 334-1k on the upper side of the first insulating substrate and the metal plate 356 formed by the conductor pattern 334-2k on the second insulating substrate overlap and by the gap between them, in other words by the thickness of the first insulating substrate 334-1. And the latter capacitance Cₛ is determined by the area by which the metal plate 356 formed by the conductor pattern 334-2k on the upper side of the second insulating substrate and the conductor pattern 334-2r (i.e. the second conductor) on the lower side of the second insulating substrate are overlapped and by the gap between them, in other words by the thickness of the second insulating substrate 334-2. In the following, the causes for generation of emissions will be explained by using concrete numerical values related to the dimensions, the frequencies, the parasitic capacitances, and the impedances of the various structural elements. In this embodiment, the frequency f_{∞} at which the insulating substrate 334 reaches high impedance is set to 100 MHz, and the design values for the various structural elements are determined by taking, as a premise, that the parallel resonator will be formed within an insulating substrate that has the same dimensions as the prior art structure previously described (i.e. around 50 mm×30 mm). The parasitic capacitance (Cₚ) shown in FIG. 8C is given as desired by the area of overlap between the conductor pattern 334-1k and the metal plate 356, and is set to less than or equal to 100 pF, according to the example of construction shown in FIG. 6. In order to provide a parallel resonator having this parasitic capacitance (Cₚ) 353 and the resonant frequency of 100 MHz, it is necessary for the inductance of the planar inductor (L) 355 to be several tens of nH. As one example of such a planar inductor (L) 355 within the dimensions of the insulating substrate described above, by making the inductor 355 in a curving spiral shape having three turns and with a maximum diameter of 25 mm, a conductor width of 3 mm, and a gap between turns of 0.7 mm, an inductance of around 70 nH may be provided. In this embodiment, by using an inductor of this shape, the arrangement of the metal plate 356 is designed so that the parasitic capacitance (Cₚ) 353 used in parallel with this inductor 355 becomes around 36 pF. Moreover, since the resonant frequency f_{zero} of the series resonator at which the resonator becomes low impedance is determined by the series parasitic capacity (Cₛ) 354, accordingly it is necessary to implement a design so that f_{zero} is positioned within a frequency band for which the spectrum of the output potential of the inverter is small, or within a frequency band for which no emission standard is prescribed. Here, if f_{zero} is set to 60 MHz, then it is possible to implement a design, by adjusting the area of overlapping between the conductor pattern 334-2r and the metal plate 356 and/or the thickness of the insulating substrate, so that this parasitic capacitance (Cₛ) 354 becomes around 65 pF.

The LC resonator having the structure described above is a parallel-series type LC resonator as shown in FIG. 11B. The impedance characteristic |Z| of this resonator is as shown by the solid line in the schematic chart of FIG. 12, and the pole frequency at which it becomes high impedance is given by:

$${f}_{∞} = \frac{1}{2 π \sqrt{{LC}_{p}}}$$

while the zero frequency at which it becomes low impedance is given by:

$${f}_{zero} = \frac{1}{2 π \sqrt{L ( {C}_{p} + {C}_{s} )}}$$

What needs to be considered here is the magnitude relationship of the parasitic capacitance (Cₛ) 354 within the second insulating substrate, which is an independent variable for determining the frequency gap between the pole frequency f_{∞} and the zero frequency f_{zero} shown in FIG. 12, and the parasitic capacitance (Cₚ) 353 within the first insulating substrate. In order to make f_{∞}>>f_{zero}, it is necessary for Cₛ>>Cₚ. In order for Cₛ to be greater than Cₚ, it is necessary appropriately to adjust the overlapping area between the conductor pattern 334-1k on the first insulating substrate and the metal plate 356 and the gap between them, and the overlapping area between the metal plate 356 and the conductor pattern 334-2r and the gap between them. It should be understood that, as previously described, the parasitic capacitance (Cₚ) 353 within the first insulating substrate is determined by the overlapping area between the conductor pattern 334-1k on the first insulating substrate and the metal plate 356 that is formed in the conductor pattern 334-2k on the second insulating substrate, and by the gap between them; and the parasitic capacitance (Cₛ) 354 within the second insulating substrate is determined by the overlapping area between the metal plate 356 that is formed in the conductor pattern 334-2k upon the second insulating substrate and the conductor pattern 334-2r underneath the second insulating substrate, and by the gap between them. Due to this, the magnitude relationship Cₛ>>Cₚ may be implemented by adjusting the configuration of the metallic plate 356 in the horizontal direction, and by also giving due consideration to the aforementioned gaps in the vertical direction.

With this structure, it is possible to adjust as appropriate the shape and dimensions of the planar inductor (L) 355 and the overlapping areas between the various conductor patterns that determine the magnitudes of the parasitic capacitance (Cₚ) 353 within the first insulating substrate and of the parasitic capacitance (Cₛ) 354 within the second insulating substrate. By optimizing the parameters described above, there are the advantages that it is possible to set the pole frequency f_{∞} and the zero frequency f_{zero} as desired, and that common mode emissions countermeasures may be instituted with freedom in relation to frequency.

Furthermore, as previously described in connection with the structure of the first embodiment, in a similar manner with the structure of this embodiment, while both the pole frequency f_{∞} at which the system goes to high impedance and the zero frequency f_{zero} at which the system goes to low impedance are present, countermeasures related to the low impedance characteristic in the frequency region of the zero frequency f_{zero} may be dealt with by instituting similar measures. Here, when in the structure of the present invention the conductor pattern is used for an inductor of a parallel resonator, means for intentionally reducing the quality factor (Q) of this resonator may be implemented by narrowing down the width of a conductor in the conductor pattern 334-2k that is used when forming the planar inductor 355.

### Embodiment 3

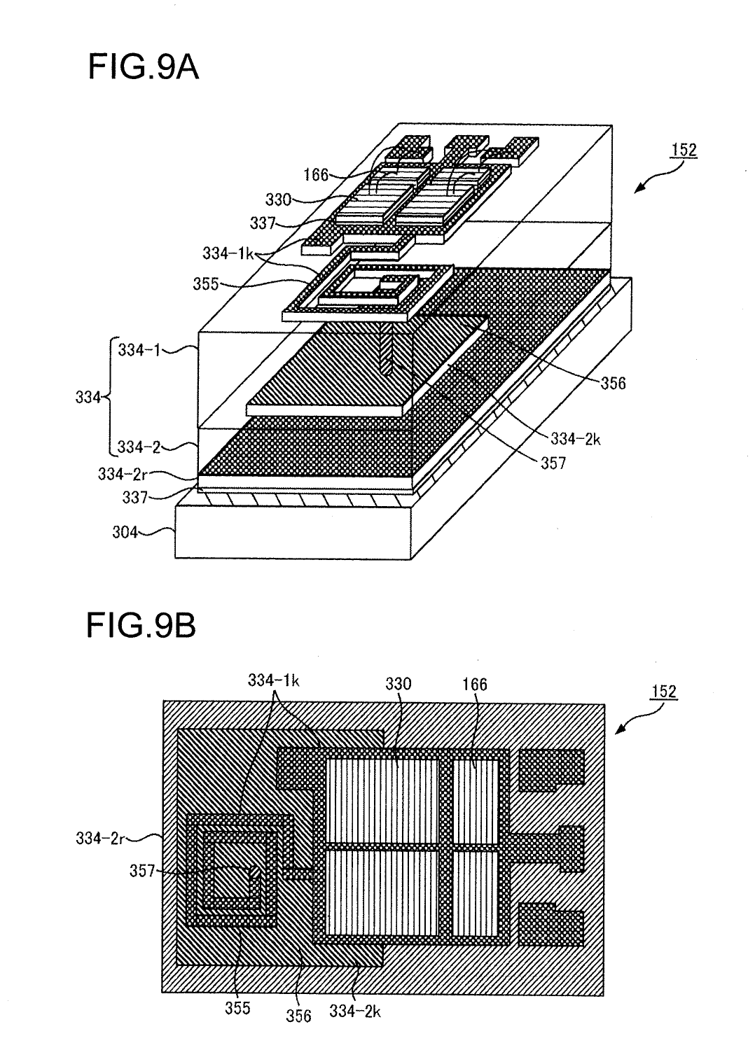

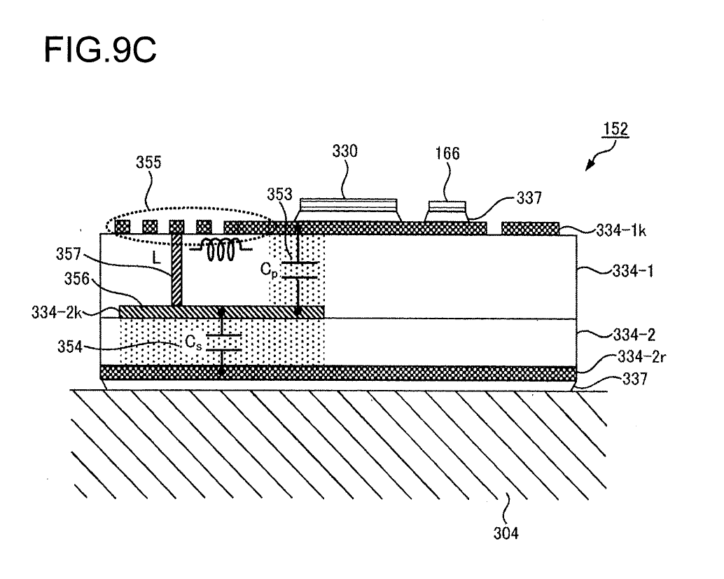

FIG. 9A is a cutaway perspective view showing the upper side of a portion of a lower arm circuit 152 to which an lower arm IGBT 330 is mounted. And FIG. 9B is a plan view thereof, while FIG. 9C is a side elevation view thereof. The difference between this embodiment and the second embodiment described above is that the planar inductor (L) 355 is formed in the conductor pattern 334-1k on the first insulating substrate. One of the outlets of this planar inductor 355 is connected to the conductor pattern 334-1k on the same layer, while the other of the outlets thereof is connected to a metal plate 356 formed in the conductor pattern 334-2k on the second insulating substrate by using the through-hole 357.

The structure of this LC resonator is the same as the structure of the second embodiment: it is a parallel-series type LC resonator, as shown in FIG. 11B. The impedance characteristic |Z| of this resonator is as shown by the solid line in the schematic graph of FIG. 12, and its pole frequency at which it has high impedance is given by:

$${f}_{∞} = \frac{1}{2 π \sqrt{{LC}_{p}}}$$

while its zero frequency at which it has low impedance is given by:

$${f}_{zero} = \frac{1}{2 π \sqrt{L ( {C}_{p} + {C}_{s} )}}$$

Furthermore, the way that the constructions of the planar inductor (L) 355, the parasitic capacitance (Cₚ) 353 of the first insulating substrate, and the parasitic capacitance (Cₛ) of the second insulating substrate are determined in order to determine this pole frequency f_{∞} and this zero frequency f_{zero} are the same as in the case of the structure of the second embodiment. If the structure of this embodiment is provided, while there is the shortcoming that the area required for implementation is increased, there is the advantageous aspect of widening the range for satisfying the condition Cₛ>>Cₚ for making f_{∞}>>f_{zero}, as previously described with reference to the structure of the second embodiment.

### Embodiment 4

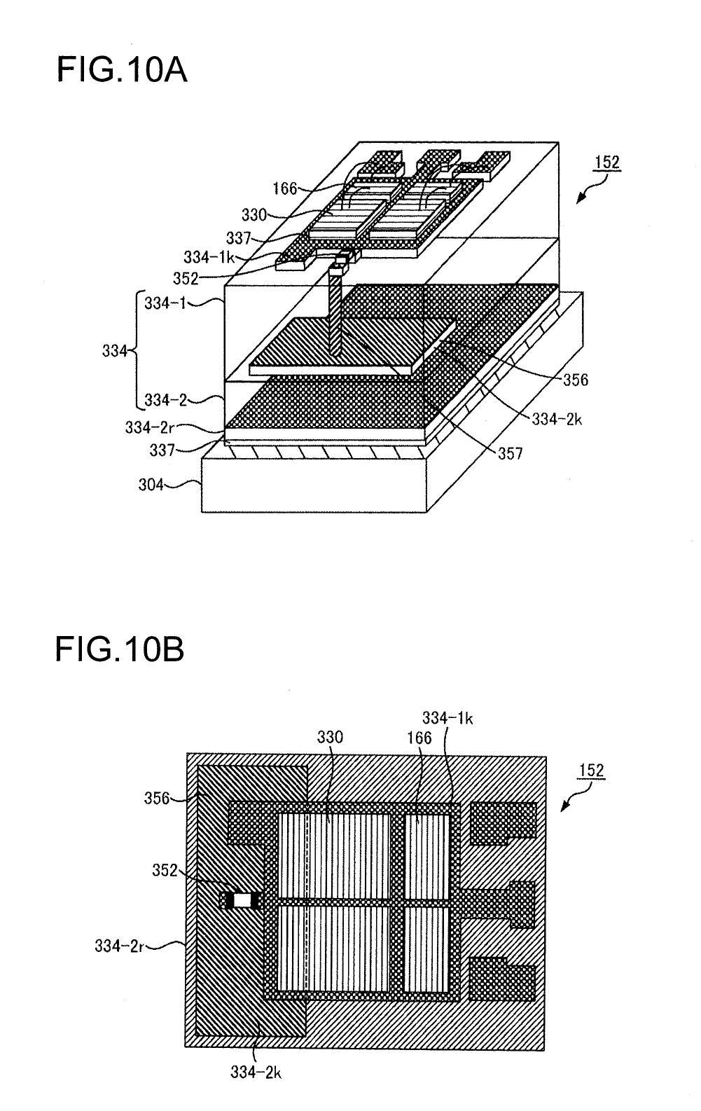

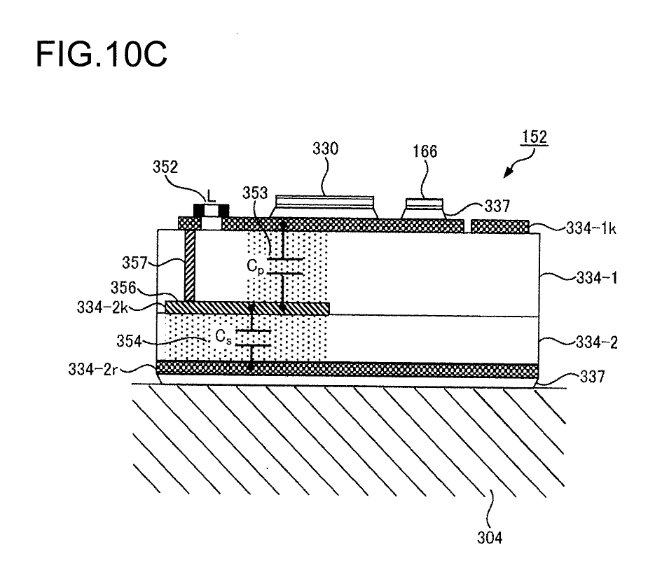

FIG. 10A is a cutaway perspective view of a fourth embodiment of the present invention, showing the upper side of a portion of a lower arm circuit 152 to which an lower arm IGBT 330 is mounted. And FIG. 10B is a cutaway plan view thereof, while FIG. 10C is a schematic cutaway side elevation view thereof. This embodiment is distinguished by the feature that the planar inductor 355 in the third embodiment that employed the conductor pattern 334-1k on the first insulating substrate for forming an LC resonator is changed to a discrete chip inductor 352, and is implemented on the front surface of the first insulating substrate using the conductor pattern 334-1k. Apart from this, the way in which the parasitic capacitance (Cₚ) 353 in the first insulating substrate and the parasitic capacitance (Cₛ) 354 in the second insulating substrate are determined during construction is the same as in the case of the second embodiment. By using a discrete chip inductor for the parallel resonator in this embodiment, it can be implemented without using up any excessive implementation area upon the power module, as compared to the structure of the third embodiment in which a planar inductor was used.

What is claimed is:

1. A circuit board included in an inverter device that outputs AC current to a motor for driving a vehicle, comprising:
an insulation layer;
a first conductor formed on a first side of the insulation layer, and upon which a semiconductor chip included in a lower arm of an inverter circuit is mounted;
a second conductor formed on a second side of the insulation layer opposite to the first side thereof, and connected to a ground of the vehicle; and
an inductor connected in parallel with a parasitic capacitance created between the first conductor and the second conductor, thus constituting a parallel resonator together with the parasitic capacitance.

2. A circuit board according to claim 1, further comprising a connecting conductor formed on the first side of the insulation layer,
wherein the inductor is a discrete chip inductor whose one terminal is connected to the second conductor and whose other terminal is connected to the connecting conductor.

3. A circuit board according to claim 2, wherein a discrete chip capacitor is connected in series with the inductor to the connecting conductor.

4. A circuit board according to claim 1, wherein the inductor is configured to have an inductance component by being constituted as a conductor pattern formed on the first side of the insulation layer, the conductor pattern extending from one end portion thereof while curving in a spiral shape centered upon its other end portion, while approaching the other end portion.

5. A circuit board according to claim 2, further comprising a second connecting conductor that electrically connects the connecting conductor formed on the first side of the insulation layer with the second conductor formed on the second side of the insulation layer, and that passes through the insulating layer.

6. A circuit board according to claim 5, wherein the second connecting conductor is a through-hole extending from the first side of the insulation layer to the second side thereof.

7. A circuit board included in an inverter device that outputs AC current to a motor for driving a vehicle, comprising:
an insulation layer;
a first conductor formed on a first side of the insulation layer, and upon which a semiconductor chip included in a lower arm of an inverter circuit is mounted;
a second conductor formed on a second side of the insulation layer opposite to the first side thereof, and connected to a ground of the vehicle;
a middle conductor formed within the insulation layer, and disposed so that its one surface faces towards the first conductor while its other surface faces towards the second conductor; and
an inductor connected in parallel with a first parasitic capacitance created between the first conductor and the middle conductor, with this parallel combination being connected in series with a second parasitic capacitance created between the middle conductor and the second conductor, so that this inductor constitutes a parallel-series resonator together with the first and second parasitic capacitances.

8. A circuit board according to claim 7, wherein the inductor is configured to have an inductance component by being constituted as a conductor pattern formed on the first side of the insulation layer using the first conductor, the conductor pattern extending from one end portion thereof while curving in a spiral shape centered upon its other end portion, while approaching the other end portion.

9. A circuit board according to claim 7, wherein the inductor is configured to have an inductance component by being constituted as a conductor pattern formed within the insulation layer using the middle conductor, the conductor pattern extending from one end portion thereof while curving in a spiral shape centered upon its other end portion, while approaching the other end portion.

10. A circuit board according to claim 7, further comprising:
a connecting conductor formed on the first side of the insulating layer; and
a discrete chip inductor of which one terminal is connected to the middle conductor and the other terminal is connected to the connecting conductor, and that is connected in series with the inductor.
